(19) United States
(12) Patent Application Publication
(10) Pub. No.: US 2023/0402764 A1
(43) Pub. Date: Dec. 14, 2023

(54) Technique For The Parallel Writing Of Metal Formed Antenna Arrays Using Lasers

(71) Applicant: UNM Rainforest Innovations, Albuquerque, NM (US)

(72) Inventors: Ganesh Balakrishnan, Albuquerque, NM (US); Christos G. Christodoulou, Albuquerque, NM (US)

(73) Assignee: UNM Rainforest Innovations, Albuquerque, NM (US)

(21) Appl. No.: 18/331,876

(22) Filed: Jun. 8, 2023

Related U.S. Application Data
(60) Provisional application No. 63/350,388, filed on Jun. 8, 2022.

(51) Int. Cl. H01Q 21/00; B23K 26/08; B23K 26/067; B23K 26/064

(52) U.S. Cl. CPC H01Q 21/0087; B23K 26/0861; B23K 26/0676; B23K 26/064; B23K 26/0884

(57) ABSTRACT

The realization of arrays of antennas for specific applications through the use of diffraction optics to create patterns that will allow for parallel writing of arrays.

### RELATED APPLICATIONS

This application claims priority to U.S. Provisional Application No. 63/350,388, filed on Jun. 8, 2022, which is incorporated herein in its entirety.

### STATEMENT REGARDING FEDERALLY SPONSORED RESEARCH & DEVELOPMENT

Not applicable.

### INCORPORATION BY REFERENCE OF MATERIAL SUBMITTED ON A COMPACT DISC

Not applicable.

### BACKGROUND OF THE INVENTION

The ability to slice, weld, and bend metal sheets and films using coherent light such as lasers provides the ability to create antennas in a dynamic and flexible manner. There have been several instances of the fabrication of such antennas with a variety of metals including nickel, copper and stainless steel.

### BRIEF SUMMARY OF THE INVENTION

In one embodiment, the present invention concerns the realization of arrays of antennas for specific applications through the use of diffraction optics to create patterns that will allow for parallel writing of arrays.

In one embodiment, the present invention concerns the realization of arrays of antennas for specific applications through the use of a hybrid robotic arm and a high precision stage to achieve movement required for such antennas.

In another embodiment, the present invention provides a method, system, and device that uses a customized diffraction optic element to create spots with equal intensities.

In another embodiment, the present invention provides a method, system, and device that uses a “photonic-lantern” to achieve to create spots with equal intensities.

In another embodiment, the present invention provides a method, system, and device having the ability to form high-performance antennas with lasers to allow for the scaling of the process to simultaneously fabricate a large array of such antennas, that could lead to the realization of low-cost phased antenna arrays.

In another embodiment, the present invention provides a method, system, and device that use optical elements such as diffraction gratings in combination with specific optical techniques to allow for the realization of an array of laser spots to form a single high-power laser which in turn will allow for the writing of hundreds of antennas on a metal sheet simultaneously.

In another embodiment, the present invention provides a method, system, and device that uses a photonic-lantern to split the high-power laser into multiple single-mode fibers that will allow for the conversion of a 100-250 Watt fiber-coupled laser into an array of smaller power lasers to fabricate antennas in parallel.

In other embodiments, the present invention makes use of a two-process translation system that consists of a laser mounted robotic arm along with the metal sample located on a high precision triple-axis translation stage.

In another embodiment, the present invention provides a method, system, and device that has a faster forming mode and a slow but extremely precise mode where the faster mode is useful in creating a thermal gradient by rapidly scanning the laser over an area while the slower more precise mode is used for cutting or welding a very precise feature on the antenna.

It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

In the drawings, which are not necessarily drawn to scale, like numerals may describe substantially similar components throughout the several views. Like numerals having different letter suffixes may represent different instances of substantially similar components. The drawings illustrate generally, by way of example, but not by way of limitation, a detailed description of certain embodiments discussed in the present document.

FIG. 1 is a schematic diagram illustrating an embodiment of the present invention.

FIG. 2 an embodiment of the present invention using a photonic lantern.

FIG. 3 shows a light pattern that may be used with an embodiment of the present invention.

FIG. 4 illustrates a robotic arm that may be used with an embodiment of the present invention.

FIG. 5 illustrates a triple axis translation stage that may be used with an embodiment of the present invention.

### DETAILED DESCRIPTION OF THE INVENTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a representative basis for teaching one skilled in the art to variously employ the present invention in virtually any appropriately detailed method, structure, or system. Further, the terms and phrases used herein are not intended to be limiting, but rather to provide an understandable description of the invention.

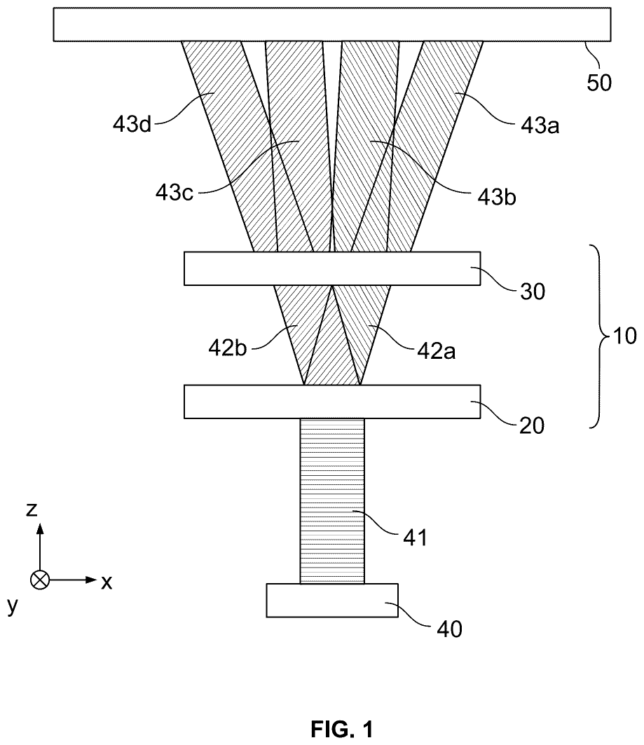

FIG. 1 is a schematic diagram illustrating a state in which light is incident on the diffractive optical element 10 according to the present embodiment, in which light emitted from the light source 40 is diffracted by the diffractive optical element 10 and projected onto the projection surface of a workpiece 50 which may be a material used to make an antenna array. As shown in FIG. 1, the diffractive optical element 10 according to the present embodiment includes a diffractive optical element 10 in which the plane of the first diffractive element 20 and the plane of the second diffractive element 30 are substantially parallel to the XY plane. Diffracted light is generated by irradiating light 41 emitted from the light source 40. The light 41 emitted from the light source 40 is first incident on the first diffractive element 20 to generate diffracted light 42a and 42b. The generated diffracted lights 42a and 42b are further incident on the second diffractive element 30, and diffracted lights 43a and 43b are generated from the diffracted light 42a, and diffracted lights 43c and 43d are generated from the diffracted light 42b. Therefore, on the projection surface 50, there are a number of light spots 60-63 that is the product of the number of light spots of the diffracted light generated by the first diffractive element 20 and the number of light spots of the diffracted light generated by the second diffractive element 30.

FIG. 3 shows a desired pattern produced by the embodiment shown in FIG. 1. As shown, a plurality of light spots of equal intensity 300-303.

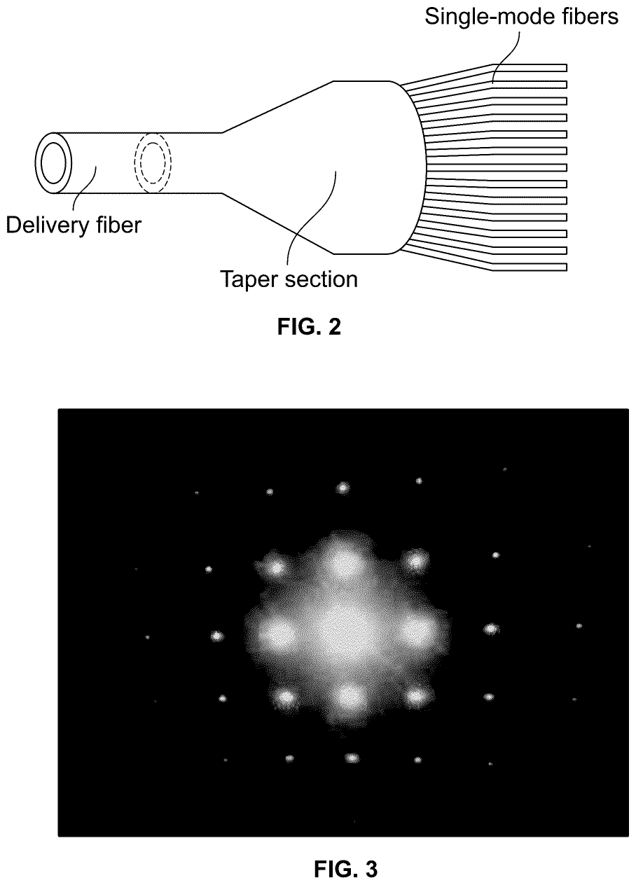

In another embodiment, the present invention makes use of a photonic-lantern 200 as shown in FIG. 2. Photonic-lantern uses delivery fiber 210 that receives light from a light source (not shown) and feeds it into a taper section 220 wherein the light is divided into a plurality of single mode fibers 230. Fibers are arranged in a desired pattern such as shown in FIG. 3. The photonic lantern splits a high-power laser into multiple single-mode fibers that will allow for the conversion of a 100-250 Watt fiber-coupled laser into an array of smaller power lasers to fabricate antennas in parallel.

The ability to form high-performance antennas with lasers also allows for the scaling of the process to simultaneously fabricate a large array of such antennas, that could lead to the realization of low-cost phased antenna arrays. The use of optical elements such as diffraction gratings in combination with specific optical techniques can allow for the realization of an array of laser spots as shown in FIG. 3 to form a single high-power laser which in turn will allow for the writing of hundreds of antennas on a metal sheet simultaneously. The fabrication of such antennas will have both manufacturing as well as scientific implications.

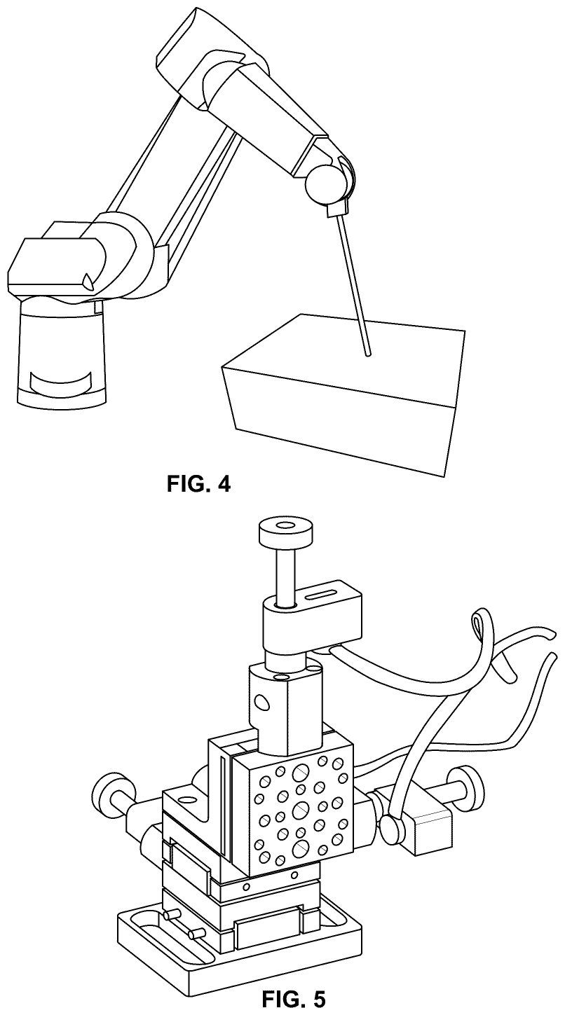

In other embodiments, as shown in FIG. 4, the present invention makes use of a two-process translation system 400 that consists of a laser mounted robotic arm 410 along with the metal sample located on a high precision triple-axis translation stage 420. The robotic arm may have a fiber-coupled to an 808 nm laser diode system attached which may be the embodiments shown in FIGS. 1 and 2.

The use of the robotic arm allows for operation at faster rates on features requiring less positional tolerance. If a higher degree of position precision is required, a triple-axis translation stage 500 may be used as shown in FIG. 5. The stage can move in increments of 30 nm. In case a very precise feature of the antenna is to be fabricated, the arm will stop moving and will hold the laser still and the process will shift to the translation stage. Thus, this combination allows provides the ability to switch between the faster and slower modes. The faster mode, which has less precision than the slower mode, may be used in creating thermal gradients by rapidly scanning the laser over an area. The slower more precise mode may be used for cutting or welding a very precise feature on the antenna.

While the foregoing written description enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above-described embodiments, methods, and examples, but by all embodiments and methods within the scope and spirit of the disclosure.

What is claimed is:

1. An optical system for the parallel writing of antenna arrays comprising:
a light source configured to transmit light to a light dividing element;
said light dividing element configured to divide said received light into a predetermined pattern comprised of a plurality of spots with equal intensities.

2. The optical system of claim 1 wherein said light dividing element is at least one diffraction grating.

3. The optical system of claim 1 wherein said light dividing element is at least one photonic lantern.

4. The optical system of claim 2 wherein said light source and said at least one diffraction grating are housed in a robotic arm.

5. The optical system of claim 2 wherein said light source and said at least one photonic lantern are housed in a robotic arm.

6. The optical system of claim 4 further including a triple-axis translation stage.

7. The optical system of claim 5 further including a triple-axis translation stage.

8. A method of creating an array of antennas: providing a workpiece;
creating an array of antennas on said workpiece by illuminating said workpiece with a predetermined pattern comprised of a plurality of light spots with equal intensities; said predetermined pattern created by a light source configured to transmit light to a light dividing element;
said light dividing element configured to divide said received light into said predetermined pattern.

9. The method of claim 8 wherein said light dividing element is at least one diffraction grating.

10. The method of claim 8 wherein said light dividing element is at least one photonic lantern.

11. The method of claim 9 wherein said light source and said at least one diffraction grating are housed in a robotic arm and said robotic arm moves said predetermined pattern on said workpiece.

12. The method of claim 10 wherein said light source and said at least one diffraction grating are housed in a robotic arm and said robotic arm moves said predetermined pattern on said workpiece.

13. The method of claim 9 wherein a triple-axis translation stage is used to move said predetermined pattern on said workpiece.

14. The method of claim 10 wherein a triple-axis translation stage is used to move said predetermined pattern on said workpiece.

15. The method of claim 9 wherein a triple-axis translation stage and a robotic arm are used to move said predetermined pattern on said workpiece.

16. The method of claim 10 wherein a triple-axis translation stage and a robotic arm are used to move said predetermined pattern on said workpiece.

17. The method of claim 9 wherein a triple-axis translation stage and a robotic arm are used to move said predetermined pattern on said workpiece; and said robotic arm configured to move said predetermined pattern on said workpiece faster than said triple-axis translation stage.

18. The method of claim 10 wherein a triple-axis translation stage and a robotic arm are used to move said predetermined pattern on said workpiece; and said robotic arm configured to move said predetermined pattern on said workpiece faster than said triple-axis translation stage.
